(19) United States
(12) Patent Application Publication
(10) Pub. No.: US 2016/0160822 A1
(43) Pub. Date: Jun. 9, 2016

(54) VIBRATION INSULATING STRUCTURE OF FUEL INJECTION VALVE IN INTERNAL COMBUSTION ENGINE

(71) Applicant: KEIHIN CORPORATION, TOKYO (JP)

(72) Inventors: Junichi MIYASHITA, SHIOYA-GUN (JP); Kousaku YOTORIYAMA, SHIOYA-GUN (JP); Takahiro YASUDA, SHIOYA-GUN (JP); Yasuhiko NABESHIMA, SHIOYA-GUN (JP); Motoki SANADA, SHIOYA-GUN (JP)

(21) Appl. No.: 14/955,758

(22) Filed: Dec. 1, 2015

(30) Foreign Application Priority Data
Dec. 4, 2014 (JP) 2014-246034
Nov. 5, 2015 (JP) 2015-217660

(51) Int. Cl. F02M 55/04; F02M 61/14

(52) U.S. Cl. CPC F02M 55/04; F02M 61/14

(57) ABSTRACT

In a vibration insulating structure of a fuel injection valve in an internal combustion engine, a vibration insulating device installed between an annular step portion of a valve installation hole provided in a cylinder head and an outer peripheral step portion of the valve fitted in the hole is formed from a ring laminated body including an upper ring engaged with the outer peripheral step portion, and at least two vibration insulating rings clamped between the upper ring and the annular step portion and superposed on each other. Multiple dents and projections each having a fine and uneven shape are formed on at least an abutment surface of each of the vibration insulating rings which abuts against an opposed one of the vibration insulating rings. Accordingly, such device can be easily obtained from a simple structure and inhibit vibration of the valve effectively, reducing vibration noise and manufacturing cost.

### BACKGROUND OF THE INVENTION

1. Field of the Invention

The present invention relates to a vibration insulating structure of a fuel injection valve in an internal combustion engine, which includes vibration insulating means installed between an outer peripheral step portion of the fuel injection valve and an annular step portion, the fuel injection valve being fitted in a valve installation hole provided in a cylinder head and capable of directly injecting fuel into a combustion chamber, the annular step portion being provided to the valve installation hole and facing the outer peripheral step portion.

2. Description of the Related Art

Conventional cylinder direct-injection-type internal combustion engines, in which fuel is directly injected from a fuel injection valve into a combustion chamber, are more likely to cause a noise problem due to vibration of the fuel injection valve while the engines are in operation. Against this background, as a measure to counter the vibration noise, for example, a technique has been known in which a vibration damping insulator, as vibration insulating means, is installed between an outer peripheral step portion of the fuel injection valve and a step portion of a valve installation hole in a cylinder head, and includes: an annular elastic member made mainly of rubber or the like; coil springs buried integrally in the elastic member; and an exterior plate covering the elastic member and the coil springs (see Japanese Patent Application Laid-open No. 2010-106758).

However, in the conventional technique, the vibration damping insulator, as the vibration insulating means, is complicated in structure, and large in the number of parts. For these reason, the conventional vibration insulator has a problem that the number of manufacturing steps is increased, thereby increasing cost.

### SUMMARY OF THE INVENTION

The present invention has been made with the foregoing situation taken into consideration. An object of the present invention is to provide a vibration insulating structure of a fuel injection valve in an internal combustion engine, which is capable of solving the above conventional problems by a simple structure.

In order to achieve the object, according to a feature of the present invention, there is provided a vibration insulating structure of a fuel injection valve in an internal combustion engine, comprising a vibration insulating device installed between an outer peripheral step portion of the fuel injection valve and an annular step portion, the fuel injection valve being fitted in a valve installation hole provided in a cylinder head and capable of directly injecting fuel into a combustion chamber, the annular step portion being provided to the valve installation hole and facing the outer peripheral step portion, wherein the vibration insulating device is formed from a ring laminated body including an upper ring which is engaged with the outer peripheral step portion, and at least two vibration insulating rings which are clamped between the upper ring and the annular step portion and superposed on each other, a plurality of dents and projections are formed on at least an abutment surface of each of the vibration insulating rings which abuts against an opposed one of the vibration insulating rings, and the plurality of dents and projections are formed fine and uneven in shape.

According to the feature of the present invention, the vibration insulating device to be installed between the fuel injection valve and the cylinder head can be easily obtained from the simple structure in which at least the two vibration insulating rings are only vertically superposed on each other immediately under the upper ring in contact with the outer peripheral step portion of the fuel injection valve, the vibration insulating rings having mutual abutment surfaces with the multiple dents and projections that are formed fine and uneven in shape. Furthermore, the overall spring constant of the vibration insulating device can be effectively reduced by the simple structure, and vibration of the fuel injection valve can be inhibited. For this reason, vibration noise of the fuel injection valve can be reduced by the simple structure effectively and at low cost.

The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 includes: a sectional view of a main part of an internal combustion engine, showing an attached state of a fuel injection valve to a cylinder head in a state where vibration insulating means (a ring laminated body) of an embodiment of the present invention is installed between the fuel injection valve and the cylinder head; and an enlarged sectional view and a perspective view of the ring laminated body.

FIGS. 2A to 2C are elevation views of rings forming the ring laminated body, respectively.

FIG. 3 is an enlarged sectional view showing a state where first and second vibration insulating rings of the ring laminated body are in contact with each other (an enlarged sectional view of a part indicated by an arrow 3 in FIG. 1).

FIG. 4 is a graph showing a relationship between displacement and load for each of rings corresponding to the vibration insulating rings of the present invention and differing from one another in terms of surface roughness, as well as for a ring of a comparative example with neither dents nor projections formed on its abutment surface which abuts against an opposed ring.

### DESCRIPTION OF THE PREFERRED EMBODIMENTS

Next, an embodiment of the present invention will be described based on the accompanying drawings.

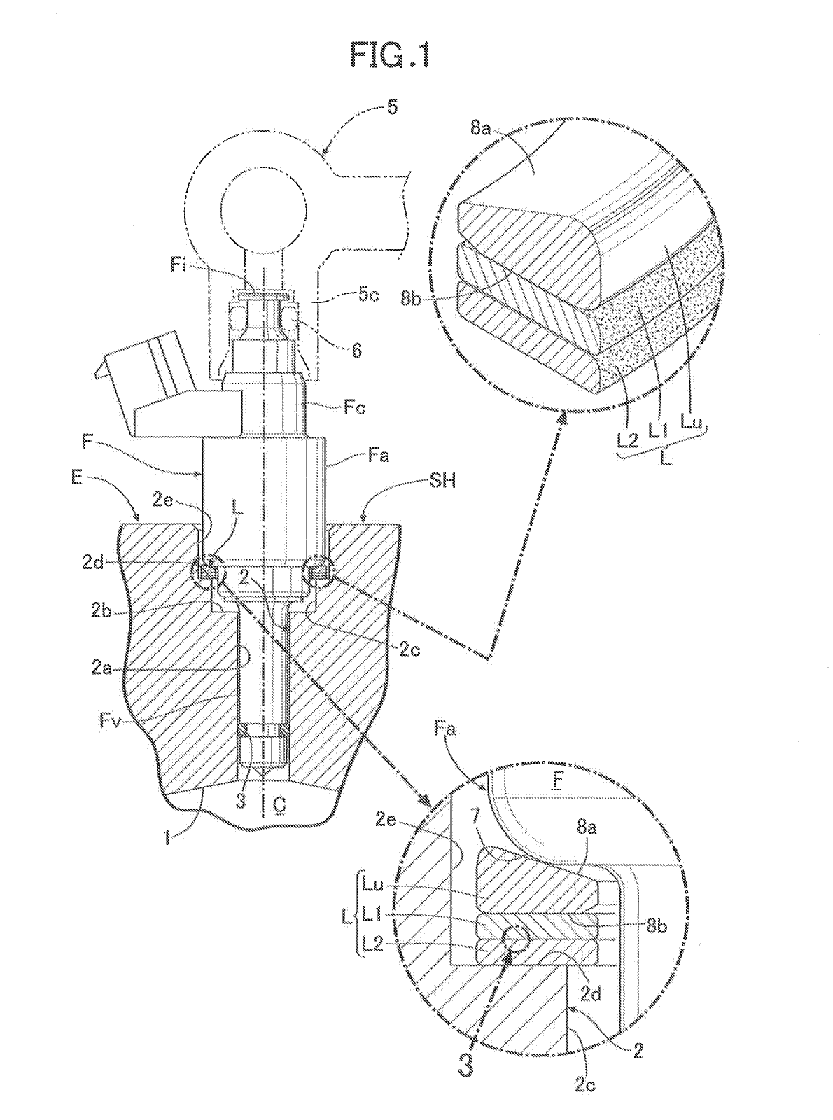

As shown in FIG. 1, multiple recessed portions 1 defining multiple combustion chambers C in cooperation with a cylinder block and pistons which are not illustrated are formed in a lower surface of a cylinder head SH of a fuel-direct-injection-type multi-cylinder internal combustion engine E. Corresponding to the combustion chambers C, valve installation holes 2 which vertically penetrate the cylinder head SH are formed in the cylinder head SH. Lower ends of the valve installation holes 2 respectively communicate with upper portions of the combustion chambers C, while upper ends of the valve installation holes 2 communicate with a space above the cylinder head SH. Fuel injection valves F capable of directly injecting fuel into the combustion chambers C are fitted in the valve installation holes 2, respectively.

Each valve installation hole 2 is formed in a stepped hole shape, and includes: a small-diameter hole portion 2a whose lower end is opened to the corresponding combustion chamber C; an intermediate hole portion 2c continuous to an upper end of the small-diameter hole portion 2a via a first step portion 2b; and a large-diameter portion 2e continuous to an upper end of the intermediate hole portion 2c via a second step portion 2d as an annular step portion. In addition, an upper end of the large-diameter portion 2e is opened in an upper surface of the cylinder head SH. From the opening, the corresponding fuel injection valve F can be fitted in the valve installation hole 2.

On the other hand, the fuel injection valves F to be fitted in the respective valve installation holes 2 each includes: a valve housing portion Fv which has a fuel injection port in its lower end, and whose diameter is relatively small; an actuator housing portion Fa which is continuous to an upper end of the valve housing portion Fv, and whose diameter is relatively large; an energization coupler portion Fc continuous to an upper end of the actuator housing portion Fa; and a fuel introducing portion Fi continuous to an upper end of the coupler portion Fc. Furthermore, the valve housing portion Fv and the actuator housing portion Fa of the fuel injection valve F are respectively inserted in the small-diameter hole portion 2a and the large-diameter portion 2e of the valve installation hole 2. Moreover, an O-ring 3 is compressedly installed between the valve housing portion Fv and the small-diameter hole portion 2a, and hermetically seals the interstice therebetween.

Delivery pipes 5 forming parts of a fuel supply system extending from a fuel tank to the fuel injection valves F are detachably attached to an upper portion of the cylinder head SH by fastening means (not illustrated) such as bolts and the like. In addition, multiple injector caps 5c integrally provided to the respective delivery pipes 5 are fitted to the fuel introducing portions Fi of the multiple fuel injection valves F in such a way to cover the fuel introducing portions Fi from above. An O-ring 6 is compressedly installed between fitting surfaces of each injector cap 5c and the corresponding fuel introducing portion Fi, and hermetically seals the interstice therebetween.

Meanwhile, the actuator housing portion Fa of each fuel injection valve F is formed in a stepped cylinder shape. An outer peripheral step portion 7 located near a lower end of the actuator housing portion Fa is formed as an annular rounded surface which becomes gradually smaller in diameter and more rounded toward below. Furthermore, a ring laminated body L forming vibration insulating means of the present invention is installed between mutually-facing surfaces of the outer peripheral step portion 7 and the second step portion 2d of the corresponding valve installation hole 2.

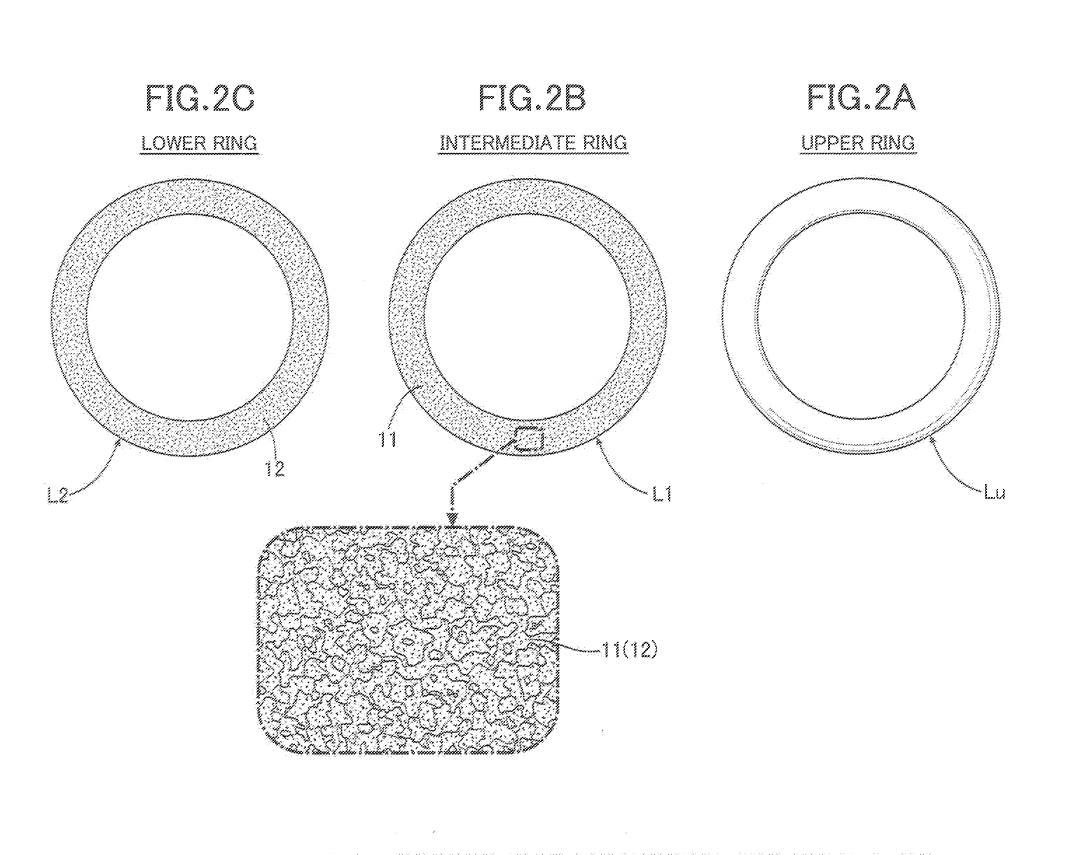

Next, referring to FIGS. 2A to 4 together, concrete descriptions will be provided for the configuration and function of the ring laminated body L. The ring laminated body L is formed from: an upper ring Lu which is engaged with the outer peripheral step portion 7 of the fuel injection valve F; and two first and second vibration insulating rings L1, L2 which are clamped between the upper ring Lu and the annular step portion 2d of the valve installation hole 2, and superposed on each other.

It should be noted that; in the embodiment, the rings Lu, L1, L2 are each made of a stainless material; however, the rings Lu, L1, L2 may be made of any of various metal materials other than the stainless material. In addition, the rings Lu, L1, L2 may be made of the same material. Otherwise, at least one ring may be made of a material different from that of the other rings. Furthermore, the number of vibration insulating rings L1, L2 may be three or more.

In the embodiment, an upper surface 8a of the upper ring Lu is formed in a conical tapered shape such that a diameter of the upper surface 8a becomes gradually larger toward above, while a lower surface 8b of the upper ring Lu is formed in a flat surface shape which is orthogonal to an axis of the ring (accordingly, a vertical axis of the fuel injection valve F). When the upper surface 8a with the conical tapered shape is engaged with the rounded surface of the outer peripheral step portion 7 of the fuel injection valve F, the upper surface 8a obtains good surface contact with the outer peripheral step portion 7, and is capable of inhibiting eccentricity between the injector cap 5c and the fuel introducing portion Fi of the fuel injection valve F by exerting a function of automatic alignment to the fuel injection valve F. Incidentally, the upper ring Lu is formed into the shape of a ring by pressing or cutting. Unlike the outer surfaces of the below-described vibration insulating rings L1, L2, the outer surfaces of the upper ring Lu is subjected to no process for reducing spring constant.

Moreover, the first and second vibration insulating rings L1, L2 are each formed from an annular ring plate whose upper and lower surfaces are flat surfaces orthogonal to the axis of the ring (accordingly the vertical axis of the fuel injection valve F). In addition, at least an abutment surface (in the embodiment, an entire outer surface) of each of the vibration insulating rings L1, L2 which abuts against an opposed one of the vibration insulating rings L1, L2 are subjected to the process for reducing spring constant.

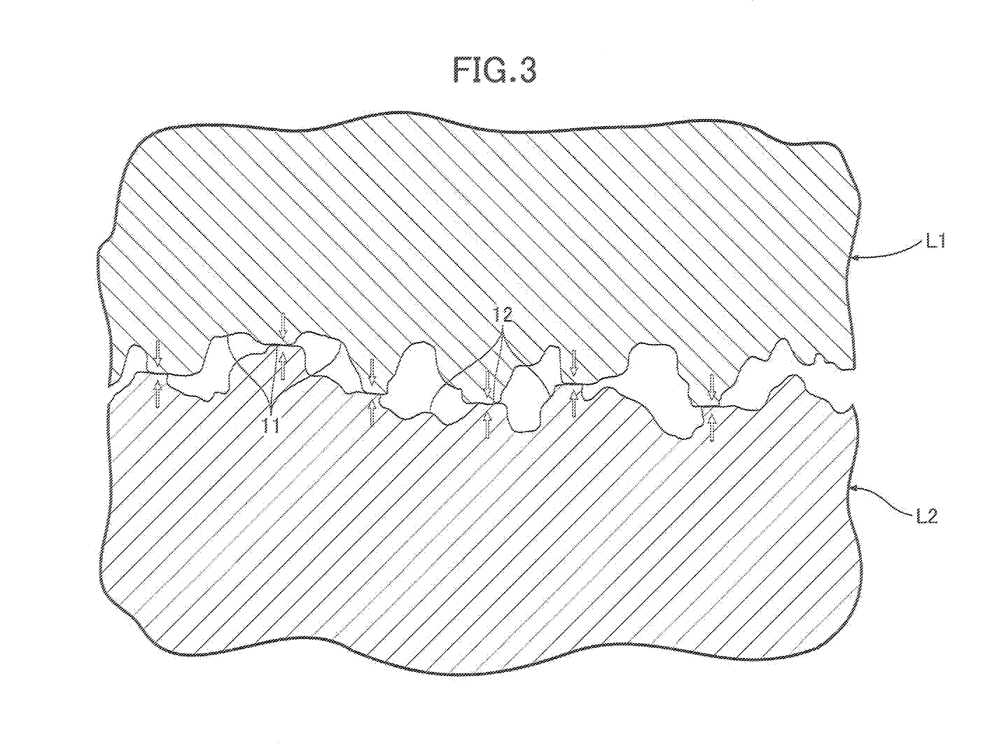

To put it concretely, in the embodiment, as the process for reducing spring constant, a rolling process for a ring-shaped workpiece, for example, is applied to the respective outer surfaces of the vibration insulating rings L1, L2. Thereby, multiple dents and projections 11, 12 which are formed fine and uneven in shape (see FIGS. 2A to 3) are formed on the respective outer surfaces of the vibration insulating rings L1, L2. This rolling process is achieved using, for example, processing rollers whose surfaces (that is, contact surfaces with a to-be-rolled material) are provided with multiple dents and projections which are formed fine and uneven in shape. The vibration insulating rings L1, L2 may be produced by: rolling the to-be-rolled material by the thus-prepared rollers; and machining the rolled workpiece into a predetermined ring shape.

Next, descriptions will be provided for an operation of the embodiment of the present invention with the foregoing configuration.

The ring laminated body L, as the vibration insulating means of the embodiment, has a simple three-layered structure obtained by only superposing the constituent upper ring Lu and the constituent two first and second vibration insulating rings L1, L2 in order from above. Furthermore, the installation of the ring laminated body L in the cylinder head SH may be achieved by: placing the ring laminated body L as a whole (or the ring L2, the ring L1 and the ring Lu sequentially from under) on the second step portion 2d of the valve installation hole 2 with no fuel injection valve F installed in the valve installation hole 2; thereafter inserting the fuel injection valve F into the valve installation hole 2; subsequently press-fitting the injector cap 5c of the delivery pipe 5 to the fuel introducing portion Fi of the fuel injection valve F via the O-ring 6; and fixing the delivery pipe 5 to the cylinder head SH. Thereby, the ring laminated body L is clamped between the mutually-facing surfaces of the outer peripheral step portion 7 of the fuel injection valve F and the second step portion 2d of the valve installation hole 2.

Meanwhile, while the direct-injection-type multi-cylinder internal combustion engine E is in operation, the fuel injection valve F is more likely to vibrate due to combustive explosion of an air-fuel mixture in the combustion chamber C. As a measure to counter this, the embodiment is configured such that: the ring laminated body L for inhibiting the vibration of the fuel injection valve F is installed between the valve installation hole 2 and the fuel injection valve F; and as shown in FIGS. 2A to 3, parts of the ring laminated body L, that is, the first and second vibration insulating rings L1, L2 have the respective outer surfaces on which the multiple dents and projections 11, 12 that are formed fine and uneven in shape are formed by applying the rolling process to the outer surfaces.

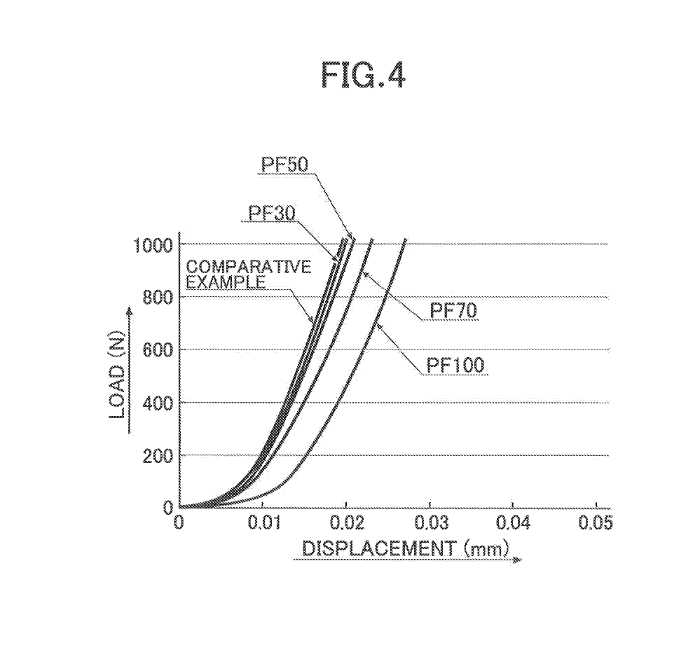

Thus, when the two vibration insulating rings L1, L2, as superposed on each other, are clamped between the upper ring Lu and the annular step portion 2d of the valve installation hole 2, the vibration insulating rings L1, L2 enter a contact mode in which only part of the dents and projections 11, 12 of the outer surface of the ring L1 is in contact with only part of the dents and projections 11, 12 of the outer surface of the ring L2. For this reason, contact area between the rings becomes smaller, and the contact portions of the rings become more likely to undergo compressive deformation due to a decrease in their rigidity, than in a case where contact is made between two rings in the same shape which include no such dents or projections 11, 12, that is, are not subjected to the above-described process (i.e., a comparative example which will be described later). Thus, as is clear from FIG. 4, the spring constant in a region of contact between the vibration insulating rings L1, L2 substantially decreases, and accordingly, the overall spring constant of the ring laminated body L decreases as well. Consequently, when vibration load is transmitted from the fuel injection valve F to the ring laminated body L while the engine is in operation, the vibration can be effectively inhibited by the compressive deformation, and vibration noise can be reduced.

Meanwhile, in FIG. 4, the horizontal axis represents displacement which occurs in each ring as a single unit when load acts on the ring, while the vertical axis represents an amount of load. Based on experimental data, FIG. 4 graphs a relationship between the displacement and the load (i.e., the spring constant represented by an inclination between the displacement and the load) for each of multiple kinds of rings corresponding to the vibration insulating rings of the present invention and differing from one another in terms of surface roughness of the external surface, as well as for a ring of the comparative example which is not subjected to the rolling process (accordingly, has none or almost none of the multiple dents and projections on its outer surface). In this respect, a count of PF finishing (where PF stands for “Pearly Finish” which is a registered trademark of Nippon Kinzoku Co., Ltd.) is correlational to a degree of surface roughness of the external surface of each ring. As the number representing the count of the PF finish becomes larger, the size of the dents and projections 11, 12 becomes larger. From FIG. 4, it is learned that: the spring constant of the ring of the comparative example is the largest; and the spring constant of each of the multiple kinds of rings which correspond to the vibration insulating rings L1, L2 of the present invention, and which are different from one another in terms of surface roughness, becomes smaller as the number representing the count of the PF finishing corresponding to the surface roughness becomes larger (i.e., the size of the fine dents and projections 11, 12 becomes larger).

Thus, according to the embodiment, the vibration insulating means (i.e., the ring laminated body L) to be installed between the fuel injection valve F and the cylinder head SH can be easily obtained from the simple structure of only superposing vertically the pair of upper and lower first and second vibration insulating rings L1, L2 on each other immediately under the upper ring Lu in direct engagement with the outer peripheral step portion 7 of the fuel injection valve F, the first and second vibration insulating rings L1, L2 having surfaces subjected to the process for reducing spring constant, for example the rolling process. Furthermore, the overall spring constant of the vibration insulating means L can be effectively reduced by the process applied to the surfaces of the first and second vibration insulating rings L1, L2, and the vibration of the fuel injection valve F can be inhibited while the engine is in operation. For this reason, the vibration noise of the fuel injection valve F can be reduced by the simple structure effectively and at low cost.

Moreover, the process can be achieved sufficiently by only forming on the surfaces of the vibration insulating rings L1, L2 the multiple dents and projections 11, 12 which are formed fine and uneven in shape. For this reason, the process is relatively easy to perform, and a reduction in the number of manufacturing steps, accordingly a cost reduction, can be achieved.

Although the embodiment of the present invention has been described, various design changes can be made to the present invention without departing from the gist of the present invention.

For example, the foregoing embodiment has been shown in which each delivery pipe 5 detachably attached to the upper portion of the cylinder head SH with bolts or the like and forming part of the fuel supply system is prevented from coming off the valve installation hole 2 of the fuel injection valve F since the delivery pipe 5 is fitted to and covers the fuel introducing portion Fi of the fuel injection valve F. Nevertheless, the coming-off preventing means is not limited to the embodiment, and various structures are applicable to the means. For example, the prevention of the delivery pipe 5 from coming off the valve installation hole 2 of the fuel injection valve F may be achieved using a specialized coming-off preventing member which can be attached and fixed to the cylinder head SH separately and independently from the delivery pipe 5, and which can be engaged with the fuel injection valve F.

What is claimed is:

1. A vibration insulating structure of a fuel injection valve in an internal combustion engine, comprising
a vibration insulating device installed between an outer peripheral step portion of the fuel injection valve and an annular step portion, the fuel injection valve being fitted in a valve installation hole provided in a cylinder head and capable of directly injecting fuel into a combustion chamber, the annular step portion being provided to the valve installation hole and facing the outer peripheral step portion, wherein
the vibration insulating device is formed from a ring laminated body including
an upper ring which is engaged with the outer peripheral step portion, and
at least two vibration insulating rings which are clamped between the upper ring and the annular step portion and superposed on each other,
a plurality of dents and projections are formed on at least an abutment surface of each of the vibration insulating rings which abuts against an opposed one of the vibration insulating rings, and
the plurality of dents and projections are formed fine and uneven in shape.
